(19) United States
(12) Patent Application Publication
(10) Pub. No.: US 2024/0019947 A1
(43) Pub. Date: Jan. 18, 2024

(54) ROTATABLE KNOB SYSTEM CONFIGURATION

(71) Applicant: Synaptics Incorporated, San Jose, CA (US)

(72) Inventors: Tomohiro Hirakawa, Chiba (JP); Nobukazu Tanaka, Tokyo (JP); Takayuki Noto, Tokyo (JP)

(21) Appl. No.: 18/046,237

(22) Filed: Oct. 13, 2022

Related U.S. Application Data
(60) Provisional application No. 63/389,623, filed on Jul. 15, 2022.

(51) Int. Cl. G06F 3/0362; G06F 3/041; G06F 3/039

(52) U.S. Cl. CPC G06F 3/0362; G06F 3/041; G06F 3/0393

(57) ABSTRACT

A rotatable knob system includes: a panel comprising a plurality of sensor electrodes; and a rotatable knob interface comprising a rotary wheel and a fixed base, wherein the fixed base comprises knob sensing electrodes and a ground pad. The knob sensing electrodes of the fixed base are disposed over the knob sensing electrodes of the plurality of sensor electrodes of the panel, and the ground pad is disposed over reference electrodes of the panel. The panel comprises a plurality of traces which connect the knob sensing electrodes of the panel to a processing system, and the plurality of traces connecting the knob sensing electrodes of the panel to the processing system do not overlap with the reference electrodes of the panel.

### CROSS-REFERENCE TO RELATED APPLICATIONS

This application claims benefit to U.S. Provisional Patent Application No. 63/389,623, filed on Jul. 15, 2022, which is hereby incorporated by reference herein in its entirety.

### BACKGROUND

Input devices including proximity sensor devices may be used in a variety of electronic systems. A proximity sensor device may include a sensing region, demarked by a surface, in which the proximity sensor device determines the presence, location, force and/or motion of one or more input objects. Proximity sensor devices may be used to provide interfaces for the electronic system. For example, proximity sensor devices may be used as input devices for larger computing systems, such as touchpads integrated in, or peripheral to, notebook or desktop computers. Proximity sensor devices may also often be used in smaller computing systems, such as touch screens integrated in cellular phones.

Additionally, proximity sensor devices may be implemented as part of a multimedia entertainment system of an automobile. In such cases, a knob may be interfaced to a proximity sensor device.

### SUMMARY

In an exemplary embodiment, the present disclosure provides a rotatable knob system. The rotatable knob system includes: a panel comprising a plurality of sensor electrodes; and a rotatable knob interface comprising a rotary wheel and a fixed base, wherein the fixed base comprises knob sensing electrodes and a ground pad. The knob sensing electrodes of the fixed base are disposed over the knob sensing electrodes of the plurality of sensor electrodes of the panel, and the ground pad is disposed over reference electrodes of the panel. The panel comprises a plurality of traces which connect the knob sensing electrodes of the panel to a processing system, and the plurality of traces connecting the knob sensing electrodes of the panel to the processing system do not overlap with the reference electrodes of the panel.

In a further exemplary embodiment, the panel is a touch-sensitive display panel.

In a further exemplary embodiment, the panel comprises a plurality of slices corresponding respectively to a plurality of analog front ends (AFEs), wherein the plurality of sensor electrodes of the panel include a first plurality of sensor electrodes corresponding to a first slice of the plurality of slices and a second plurality of sensor electrodes corresponding to a second slice of the plurality of slices.

In a further exemplary embodiment, the ground pad of the fixed base is disposed over the first slice, and wherein the knob sensing electrodes of the fixed base are disposed over the second slice.

In a further exemplary embodiment, the ground pad of the fixed base and the knob sensing electrodes of the fixed base are disposed in the same slice.

In a further exemplary embodiment, the knob sensing electrodes of the fixed base are disposed over the second slice; the system further comprises the processing system; and the processing system is configured to perform knob sensing via the knob sensing electrodes of the panel in a same time instance as performing touch sensing for the second slice.

In a further exemplary embodiment, the knob sensing electrodes of the fixed base are disposed over the second slice; the system further comprises the processing system; and the processing system is configured to perform knob sensing via the knob sensing electrodes of the panel in a time instance during which touch sensing is not performed.

In another exemplary embodiment, the present disclosure provides a rotatable knob system. The rotatable knob system includes: a panel comprising a plurality of sensor electrodes; and a rotatable knob interface comprising a rotary wheel and a fixed base, wherein the fixed base comprises knob sensing electrodes and a ground pad. The knob sensing electrodes of the fixed base are disposed over the knob sensing electrodes of the plurality of sensor electrodes of the panel, and the ground pad is disposed over reference electrodes of the panel. The panel comprises a first plurality of traces which connect the knob sensing electrodes of the panel to a processing system and a second plurality of traces which connect the reference electrodes of the panel to the processing system, wherein the second plurality of traces are separate from the first plurality of traces.

In a further exemplary embodiment, the panel is a touch-sensitive display panel.

In a further exemplary embodiment, the panel comprises a plurality of slices corresponding respectively to a plurality of analog front ends (AFEs), wherein the plurality of sensor electrodes of the panel include a first plurality of sensor electrodes corresponding to a first slice of the plurality of slices and a second plurality of sensor electrodes corresponding to a second slice of the plurality of slices.

In a further exemplary embodiment, the ground pad of the fixed base is disposed over the first slice, and wherein the knob sensing electrodes of the fixed base are disposed over the second slice.

In a further exemplary embodiment, the ground pad of the fixed base and the knob sensing electrodes of the fixed base are disposed in the same slice.

In a further exemplary embodiment, the knob sensing electrodes of the fixed base are disposed over the second slice; the system further comprises the processing system; and the processing system is configured to perform knob sensing via the knob sensing electrodes of the panel in a same time instance as performing touch sensing for the second slice.

In a further exemplary embodiment, the knob sensing electrodes of the fixed base are disposed over the second slice; the system further comprises the processing system; and the processing system is configured to perform knob sensing via the knob sensing electrodes of the panel in a time instance during which touch sensing is not performed.

In yet another exemplary embodiment, the present disclosure provides a method for knob sensing. The method includes: providing a rotatable knob interface on a panel of an input device, the knob interface having a fixed base and a rotary wheel, wherein the panel comprises a plurality of sensor electrodes, wherein the fixed base comprises knob sensing electrodes and a ground pad, wherein the knob sensing electrodes of the fixed base are disposed over the knob sensing electrodes of the plurality of sensor electrodes of the panel, and the ground pad is disposed over reference electrodes of the panel, wherein the panel comprises a plurality of traces which connect the knob sensing electrodes of the panel to a processing system, and wherein the plurality of traces connecting the knob sensing electrodes of the panel to the processing system do not overlap with the reference electrodes of the panel; providing, by a processing system of the input device, a reference signal to the reference electrodes of the panel and sensing signals to the knob sensing electrodes of the panel; obtaining, by the processing system, resulting signals via the knob sensing electrodes of the panel; and determining a change in rotational position and a direction of rotation of the knob interface based, at least in part, on the obtained resulting signals.

In a further exemplary embodiment, the panel comprises a plurality of slices corresponding respectively to a plurality of analog front ends (AFEs), wherein the plurality of sensor electrodes of the panel include a first plurality of sensor electrodes corresponding to a first slice of the plurality of slices and a second plurality of sensor electrodes corresponding to a second slice of the plurality of slices.

In a further exemplary embodiment, the ground pad of the fixed base is disposed over the first slice, and wherein the knob sensing electrodes of the fixed base are disposed over the second slice.

In a further exemplary embodiment, the ground pad of the fixed base and the knob sensing electrodes of the fixed base are disposed in the same slice.

In a further exemplary embodiment, the knob sensing electrodes of the fixed base are disposed over the second slice; and knob sensing is performed via the knob sensing electrodes of the panel in a same time instance as performing touch sensing for the second slice.

In a further exemplary embodiment, the knob sensing electrodes of the fixed base are disposed over the second slice; and knob sensing is performed via the knob sensing electrodes of the panel in a time instance during which touch sensing is not performed.

### BRIEF DESCRIPTION OF THE DRAWINGS

FIG. 1 depicts an example input device with a rotatable knob interface.

FIG. 2 illustrates a cross-sectional side view of an example rotatable knob interface, according to one or more embodiments.

FIG. 3 illustrates an exploded view of the example rotatable knob interface of FIG. 2.

FIG. 4A illustrates an underside view of the fixed base of an example rotatable knob interface as shown in FIG. 3 with a first set of reference electrodes, and two sets of sensing electrodes according to one or more embodiments.

FIG. 4B illustrates an example portion of an input device with an electrode grid, the grid configured into two sets of electrodes, according to one or more embodiments.

FIG. 4C illustrates the fixed base of an example rotatable knob interface of FIG. 4A as positioned over the example sensor grid of FIG. 4B, according to one or more embodiments.

FIG. 5 depicts a simplified illustration of a fixed base of a rotatable knob interface.

FIG. 6A depicts the fixed base of FIG. 5 overlaid on an exemplary display panel having a plurality of sensing electrodes.

FIG. 6B depicts an illustrative example of capacitive loadings caused by grounded reference electrodes and their corresponding vertical traces based on the location and orientation of the fixed base of a rotatable knob shown in FIG. 6A.

FIG. 7A depicts the fixed base of FIG. 5 overlaid on an exemplary display panel having a plurality of sensing electrodes in accordance with an exemplary embodiment of the present disclosure.

FIG. 7B depicts an illustrative example of capacitive loadings caused by grounded reference electrodes and their corresponding vertical traces based on the location and orientation of the fixed base of a rotatable knob shown in FIG. 7A.

FIG. 8A depicts the fixed base of FIG. 5 overlaid on an exemplary display panel having a plurality of sensing electrodes in accordance with another exemplary embodiment of the present disclosure.

FIG. 8B depicts an illustrative example of capacitive loadings caused by grounded reference electrodes and their corresponding vertical traces based on the location and orientation of the fixed base of a rotatable knob shown in FIG. 8A.

FIG. 9 is a process flowchart illustrating a method for implementing a rotatable knob interface on an example electronic device, and determining a position and/or state of the rotatable knob interface according to one or more embodiments.

### DETAILED DESCRIPTION

The following description may use perspective-based descriptions such as top/bottom, in/out, over/under, and the like. Such descriptions are merely used to facilitate the discussion and are not intended to restrict the application of embodiments described herein to any particular orientation.

The following description may use the phrases “in one embodiment,” or “in one or more embodiments,” or “in some embodiments”, which may each refer to one or more of the same or different embodiments. Furthermore, the terms “comprising,” “including,” “having,” and the like, as used with respect to embodiments of the present disclosure, are synonymous.

The terms “coupled with,” along with its derivatives, and “connected to” along with its derivatives, may be used herein, including in the claims. “Coupled” or “connected” may mean one or more of the following. “Coupled” or “connected” may mean that two or more elements are in direct physical or electrical contact. However, “coupled” or “connected” may also mean that two or more elements indirectly contact each other, but yet still cooperate or interact with each other, and may mean that one or more other elements are coupled or connected between the elements that are said to be coupled with or connected to each other. The term “directly coupled” or “directly connected” may mean that two or elements are in direct contact.

As used herein, including in the claims, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

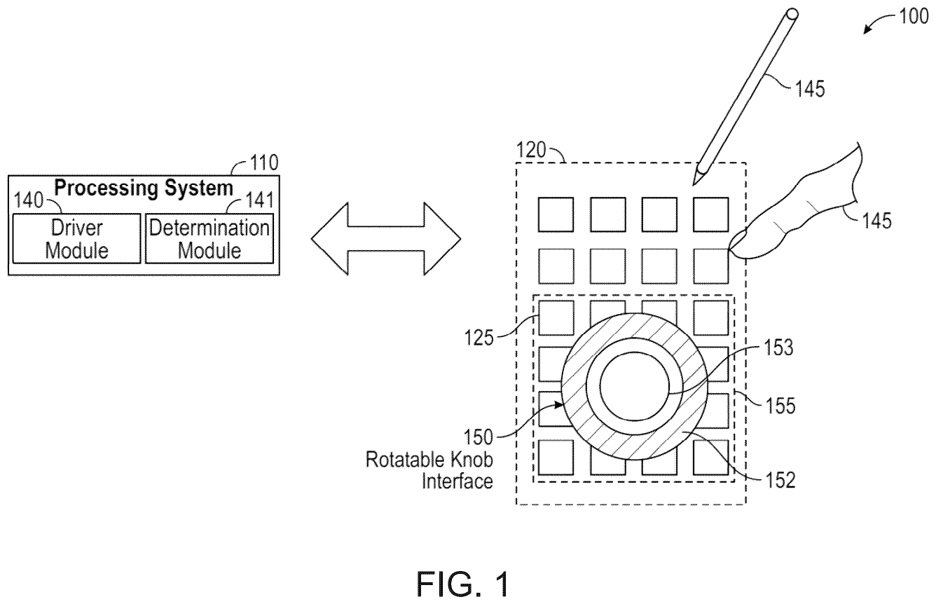

FIG. 1 is a block diagram of an exemplary electronic device 100. The electronic device 100 may be configured to provide input to an electronic system, and/or to update one or more devices. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include the electronic device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device. In other embodiments, the electronics system may be part of an automobile, and the electronic device 100 represents one or more sensing devices of the automobile. In one embodiment, an automobile may include multiple electronic devices 100, where each electronic device 100 may be configured differently than the other.

The electronic device 100 can be implemented as a physical part of the electronic system, or can be physically separate from the electronic system. As appropriate, the electronic device 100 may communicate with parts of the electronic system using any one or more of the following: buses, networks, and other wired or wireless interconnections. Example communication protocols include Inter-Integrated Circuit (I2C), Serial Peripheral Interface (SPI), Personal System/2 (PS/2), Universal Serial Bus (USB), Bluetooth®, Radio Frequency (RF), and Infrared Data Association (IrDA) communication protocols.

In one or more embodiments, the electronic device 100 may utilize any combination of sensor components and sensing technologies to detect user input. For example, as illustrated in FIG. 1, the electronic device 100 comprises one or more electrodes 125 that may be driven to detect objects or update one or more devices. In one embodiment, the electrodes 125 are sensor electrodes of a capacitive sensing device. In such embodiments, electrodes 125 include one or more common voltage electrodes. In other embodiments, the electrodes 125 are electrodes of an image sensing device, radar sensing device, and ultrasonic sensing device. Further yet, the electrodes 125 may be display electrodes of a display device. In some embodiments the electrodes 125 of the electronic device 100 are comprised of the common electrodes and have a common shape. Some of the examples described herein include a matrix sensor input device. As described in detail below, electronic device 100 may be provided with a rotatable knob interface 150, which may interact with some or all of electrodes 125.

The sensor electrodes 125 may have any shape, size and/or orientation. For example, the sensor electrodes 125 may be arranged in a two-dimensional array as illustrated in FIG. 1. Each of the sensor electrodes 125 may be substantially rectangular in shape. In other embodiments, the sensor electrodes 125 may have other shapes. Further, each of the sensor electrodes 125 may have the same shape and/or size. In other embodiments, at least one sensor electrode may have a different shape and/or size than another sensor electrode. In various embodiments, the sensor electrodes 125 may be diamond shaped, have interdigitated fingers to increase field coupling, and/or have floating cut-outs inside to reduce stray capacitance to nearby electrical conductors.

In one or more embodiments, some capacitive implementations utilize “self-capacitance” (or “absolute capacitance”) sensing methods based on changes in the capacitive coupling between sensor electrodes and an input object. In various embodiments, an input object near the sensor electrodes, such as, for example, finger or stylus 145, alters the electric field near the sensor electrodes 125, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage, or modulated with reference to the transmitter sensor electrodes to facilitate receipt of resulting signals. A resulting signal may comprise effect(s) corresponding to one or more transmitter signals, and/or to one or more sources of environmental interference (e.g., other electromagnetic signals). Sensor electrodes may be dedicated transmitters or receivers, or may be configured to both transmit and receive.

Capacitive sensing devices may be used for detecting input objects in proximity to and/or touching input devices. Further, capacitive sensing devices may be used to sense features of a fingerprint. Still further, as in the example of FIG. 1, in one or more embodiments, capacitive sensing devices may be provided with a rotatable knob interface that is coupled to the capacitive sensing device, and may be used to sense the rotary position of the rotary knob. In some embodiments that include the rotatable knob interface, the rotatable knob interface may have a home position and a compressed position, and the sensing device may also be used to determine when the rotatable knob is in the home position, and when it is in the compressed position, based on a change in capacitive coupling of one or more of electrodes 125.

Continuing with reference to FIG. 1, a processing system 110 is shown as part of the electronic device 100. The processing system 110 is configured to operate hardware of the electronic device 100. As illustrated in FIG. 1, processing system 110 comprises a driver module 140, which may include a signal generator. In one or more embodiments, the driver module 140 generates sensing signals with which to drive electrodes 125. In various embodiments, the processing system 110 comprises parts of or all of one or more integrated circuits (ICs) and/or other circuitry components.

In some embodiments, the processing system 110 also comprises electronically-readable instructions, such as firmware code, software code, and/or the like. In some embodiments, components composing the processing system 110 are located together, such as, for example, near sensing element(s) of the electronic device 100. In other embodiments, components of processing system 110 are physically separate with one or more components in proximity to the sensing element(s) of electronic device 100, and one or more components elsewhere. For example, the electronic device 100 may be a peripheral coupled to a desktop computer, and the processing system 110 may comprise software configured to run on a central processing unit (CPU) of the desktop computer and one or more integrated circuits (ICs) (perhaps with associated firmware) separate from the CPU. As another example, the electronic device 100 may be physically integrated in a phone, and the processing system 110 may comprise circuits and firmware that are part of a main processor of the phone. Further yet, the processing system 110 may be implemented within an automobile, and the processing system 110 may comprise circuits and firmware that are part of one or more of the electronic control units (ECUs) of the automobile. In some embodiments, the processing system 110 is dedicated to implementing the electronic device 100. In other embodiments, the processing system 110 also performs other functions, such as operating display screens, driving haptic actuators, etc.

The processing system 110 may be implemented as one or more modules that operate different functions of the processing system 110 (e.g., driver module 140, or determination module 141). Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes. In some embodiments, the electronic device 100 may be implemented as a chip, or as one or more chips. In some embodiments, the electronic device 100 may comprise a controller, or a portion of a controller, of electronic device 100.

In one or more embodiments, a display driver (e.g., driver module 140) may be configured for both display updating and input sensing, and may, for example, be referred to as including touch and display driver integration (TDDI) technology. In such embodiments, driver module 140 may be implemented as a TDDI chip, or a portion of a TDDI chip. In one or more embodiments, the electronic device may include matrix sensor and may also include TDDI technology.

In one or more embodiments, the processing system 110 further includes determination module 141. In one or more embodiments, the determination module 141 may be configured to determine changes in a capacitive coupling between each modulated sensor electrode and an input object, such as input objects 145, from the resulting signals. In one embodiment, all of sensor electrodes 125 may be simultaneously operated for absolute capacitive sensing, such that a different resulting signal is simultaneously received from each of the sensor electrodes or a common resulting signal from two or more sensor electrodes. In another embodiment, some of the sensor electrodes 125 may be operated for absolute capacitive sensing during a first period and others of the sensor electrodes 125 may be operated for absolute capacitive sensing during a second period that is non-overlapping with the first period.

In some embodiments, the processing system 110 responds to user input (or lack of user input) directly by causing one or more actions. Example actions include changing operation modes, as well as graphic user interface (GUI) actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions. Further, in some embodiments, the processing system 110 is configured to identify one or more objects, and the distance to these objects. In some embodiments the processing system 110 is configured to identify one or more rotational changes of knob interface 150, or one or more changes of state of knob interface 150, or both, and map those changes to desired actions.

For example, in some embodiments, the processing system 110 operates electrodes 125 to produce electrical signals (resulting signals) indicative of input (or lack of input) in a sensing region. The processing system 110 may perform any appropriate amount of processing on the electrical signals in producing the information provided to the electronic system. For example, the processing system 110 may digitize analog electrical signals obtained from the electrodes 125. As another example, the processing system 110 may perform filtering or other signal conditioning, or, as yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, recognize fingerprint information, distance to a target object, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

It should be understood that while many embodiments of the disclosure are described in the context of a fully functioning apparatus, the mechanisms of the present disclosure are capable of being distributed as a program product (e.g., software) in a variety of forms. For example, the mechanisms of the present disclosure may be implemented and distributed as a software program on information bearing media that are readable by electronic processors (e.g., non-transitory computer-readable and/or recordable/writable information bearing media readable by the processing system 110). Additionally, the embodiments of the present disclosure apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

In one or more embodiments, the processing system 110 is configured to generate a voltage signal to drive the electrodes 125 during a display update interval and an input sensing interval, respectively. In such embodiments, the voltage signal generated to drive the electrodes 125 during a display update interval is a substantially constant, or fixed voltage, and the voltage signal generated to drive the electrodes 125 during an input sensing interval may be referred to as a sensing signal, having a waveform with a periodically variable voltage. In one or more embodiments, the value of a voltage signal to drive the electrodes 125 during a display update interval may be predetermined. For example, the voltage value may be provided by a manufacturer of electronic device 100 and/or the electrodes 125, and may be device-specific to electronic device 100.

In one embodiment, the driver module 140 comprises circuitry configured to provide the sensing signal. For example, the driver module circuitry may include an oscillator, one or more current conveyers and/or a digital signal generator circuit. In one embodiment, the driver module circuitry generates the voltage signal based on a clock signal, the output of the oscillator and the parameters discussed above.

As noted above, in one or more embodiments, the driver module 140 generates a signal to drive the electrodes 125 during each of the display update periods and input sensing update periods. In such embodiments, an input sensing update period is provided in between two display update periods. In some implementations, the input sensing update period may be of a shorter duration than a display update period. In such embodiments, there are several display update periods and input sensing update periods per display frame. In one or more embodiments, by acquiring the resulting signals over successive input sensing periods the rotation of the rotatable knob interface 150, as well as whether it is in its home state or compressed state, may be tracked.

As noted above, in one or more embodiments, an additional input apparatus may be provided on top of the display panel 120 of the electronic device 100, such as, for example, the rotatable knob interface 150, and may be coupled to some or all of electrodes 125 that are positioned near or below it. In one or more embodiments, the additional apparatus may provide alternate ways for a user to provide input to electronic device 100 other than touching, or hovering near, a display screen with a finger or stylus 145. In the depicted example of FIG. 1, the rotatable knob interface 150 is mounted onto the display panel 120, and may have a full (as shown in FIG. 1) or partial overlap with the display panel 120. As noted, in one or more embodiments the rotatable knob interface 150 may have a stationary base (not visible in the top view of FIG. 1) that is provided with various sets of coupling electrodes configured to couple with respective sets of electrodes of the display panel 120, such as one or more sets of electrodes that are provided with sensing signals and one or more sets of electrodes that are provided with reference signals. In one or more embodiments, the stationary base may include different conductive regions respectively connected to corresponding sets of coupling electrodes.

In one or more embodiments, the rotatable knob interface 150 also includes a rotary wheel that sits above, and rotates relative to, the stationary base. In such embodiments, an underside of the rotary wheel is patterned with various conductive and non-conductive regions in a peripheral region 152, configured to align with the conductive regions of the stationary base so that there are various electrical couplings between the conductive regions of the stationary base and the various conductive and non-conductive regions in the peripheral region 152 of the rotary wheel. These components are further configured such that these electrical couplings change as the rotary wheel is rotated, in such manner that by detecting the effects of the changes in the electrical couplings on resulting signals received on the display panel, the input device can determine a rotation, or a change in rotation, of the knob interface. In one or more embodiments, patterned region 152 may have numerous possible example arrangements of the conductive and non-conductive regions, and there may be various ways of having the rotary wheel and the stationary base electrically interact as the rotary wheel is rotated. Thus, alternate configurations and relative arrangements of both the conductive regions of the stationary base, and the placement of the conductive and non-conductive regions of the rotary wheel are possible, all being within the scope of this disclosure.

In one or more embodiments, the rotation imparted to the rotatable knob interface by a user, in either relative or absolute terms, may be detected by the electronic device 100. In one or more embodiments, the rotatable knob interface 150 may also be pressed downwards by a user, and may thus have two positions, a home, or “uncompressed” position, and a “compressed” position, which a user maintains by, for example, pushing down on the knob interface 150 against one or more biasing springs. In one or more embodiments, the rotatable knob interface 150 has a cover. In alternate embodiments, the rotatable knob interface may be pressed downwards so as to rest at multiple positions, and thus may have multiple states between an “uncompressed” and a “fully compressed” position. In the home position the cover is at a greater distance above the rotary wheel than in the compressed position. In one or more embodiments, the rotary wheel may have several switches provided between it and the cover, these switches may include the biasing springs. In such embodiments, the rotatable knob interface 150 may be provided with a fourth set of coupling electrodes, which couple to electrodes of the input device that are also driven with sensing signals. In the example of FIG. 1, the fourth set of coupling electrodes is connected to an inner ring provided in the stationary base, which aligns with a similarly shaped inner ring 153 that is provided in the rotary wheel. In such embodiments, when a user presses down on the cover of the rotatable knob interface, so that the rotatable knob interface 150 is then in the “compressed” position, the switches close so as to connect the inner ring 153 of the rotary wheel with all of the conductive regions provided in patterned region 152. This serves to electrically couple the fourth set of coupling electrodes of the stationary base to the first set of coupling electrodes of the stationary base, thereby coupling a corresponding fourth set of electrodes of the display panel to a reference signal. However, when the user ceases to press down on the cover, the fourth set of coupling electrodes of the knob interface simply floats. In one or more embodiments, direction and degree of rotation, as well as a user pressing down on, or ceasing to press down upon, the rotatable knob interface 150, may be interpreted by processing system 110, such as, for example, by determination module 141, and may be mapped to various user input actions, signals, or directives.

It is noted that in one or more embodiments a user may rotate the rotatable knob interface 150 in various ways, for example, grabbing an outer housing of the rotatable knob interface and turning it, grabbing a top of the rotatable knob interface, or a flange protruding from the side of the rotatable knob interface and turning it, or placing one or more fingertips in or on a recessed channel on an upper surface of the rotatable knob interface.

In one or more embodiments, the electronic device 100 of FIG. 1 may be provided in an automobile. For example, it may be affixed to a substantially vertical display screen provided in a central part of a dashboard. In one or more embodiments, all the electrodes not physically blocked by the rotatable knob interface 150, whether the electrodes 125 are inside or are outside of region 155 (described below), remain active. Thus, in such embodiments, both touches away from the knob, and rotations of the knob, are detected and reported by the electrodes 125 at the same time.

In alternate embodiments, all other forms of user input besides those received via the rotatable knob interface 150 may be disabled on the electronic device. Thus, in such embodiments, the electrodes 125 are not driven during the sensing interval to perform their standard sensing functionality. As a result, if a finger or other object 145 is moved into, or away from, its vicinity, no resulting signal is obtained, or if obtained, it is not processed. In such alternate embodiments, this may be done to prevent a driver of the automobile from attempting to touch the display 120 while driving, as a safety measure, and thus to only interact with the electronic device 100 via the rotatable knob interface 150. In such alternate embodiments, the disabling of standard sensing functionality of the electrodes 125 may be implemented during specified activities of the automobile, but not during others. For example, the disabling of standard sensing functionality of the electrodes 125 may be implemented while the automobile is in actual motion, but at all other times some of the electrodes 125, for example, those not near enough to the rotatable knob interface to interfere with signals acquired from it, may be operated to perform standard sensing, as described above.

Thus, in some alternate embodiments, when all of the electrodes 125 are disabled from standard sensing, whether during actual driving of the automobile, or whether at all times, as the case may be, the only way that a driver of the automobile can provide input to the electronic device 100 is via the rotatable knob interface 150, using a pre-defined set of rotations and/or pressings of the rotatable knob interface 150. These motions modify a resulting signal which is received by the electronic device 100 during a sensing period, which then interprets them, for example, using determination module 141. The resulting signal may be the same signal as the sensing signal that driver module 140 drives an electrode 125 with, after being modified by the capacitive coupling of the rotary knob interface 150.

In other alternate embodiments, for example, only some of the electrodes 125, in particular those that are near or beneath the rotary knob interface 150, are disabled from standard capacitive sensing, and the remainder of the electrodes 125 on the electronic device 100 may still be operative for standard capacitive sensing. In such alternate embodiments, the electrodes that are disabled for standard capacitive sensing are those that are close enough to the rotatable knob interface 150 such that driving them with standard sensing signals may interfere with the resulting signals obtained from various sets of the electrodes 125 that are respectively coupled to the coupling electrodes of the rotatable knob interface 150. To illustrate this feature, in FIG. 1 there is shown a dashed line boundary 155. Electrodes 125 within the boundary 155 are in a “blackout zone” and not driven with a standard sensing signal. Rather, as described in detail below, any of the electrodes within the blackout zone that are coupled to the rotatable knob interface are driven so as to capture rotations and compressions of the rotatable knob interface, as described below.

In general, within the blackout zone, a first, second and third set of the electrodes 125 are coupled to corresponding first, second and third sets of the coupling electrodes of the stationary base of the rotatable knob interface 150. In embodiments, the first set are driven with a reference signal, and the second and third sets are driven with a sensing signal to obtain a resulting signal modified by the then extant relative rotational relationship of the stationary base and the rotary wheel of the rotatable knob interface 150. Thus, in each of these alternate embodiments, all of the electrodes within the blackout zone boundary 155 may be disabled from standard capacitive sensing at all times.

As used herein, the term “disabled electrode” may refer to an electrode that is not driven at all, an electrode that is driven with a guard signal, or one that is driven with a constant signal.

Continuing with reference to FIG. 1, as noted above, sets of electrodes of the electronic device 100 are coupled to corresponding sets of coupling electrodes of the rotatable knob interface 150. Thus, during an input sensing period a reference signal is supplied by the driver module 140 to a first set of the electrodes 125, and a sensing signal is supplied to second and third sets of the electrodes 125. In one or more embodiments, the reference signal may be a configurable direct current (DC) output provided by the processing system 110. In some embodiments, the DC signal may be a ground signal of the electronic device 100. In some embodiments, a resulting signal is obtained from each of the second and third sets of the electrodes 125, where the resulting signals is the sensing signal as modified by the rotational state of the rotatable knob interface 150. The resulting signals are interpreted by the determination module 141 to determine a rotation of the rotatable knob interface 150. In one or more embodiments, the rotation may be determined in relative terms, such as, for example, a differential angular change from a prior position, or, for example, in absolute terms, such as, for example, a positive or negative angular change from a home position. In some embodiments, if the rotatable knob is turned more than a full 360 degree turn, the overall rotational distance that it has covered may also be measured. In such embodiments, one or more user commands may be mapped to absolute rotational distance. In alternate embodiments, only the one or both of overall angular change between starting position and ending position, or final absolute angular position, is measured.

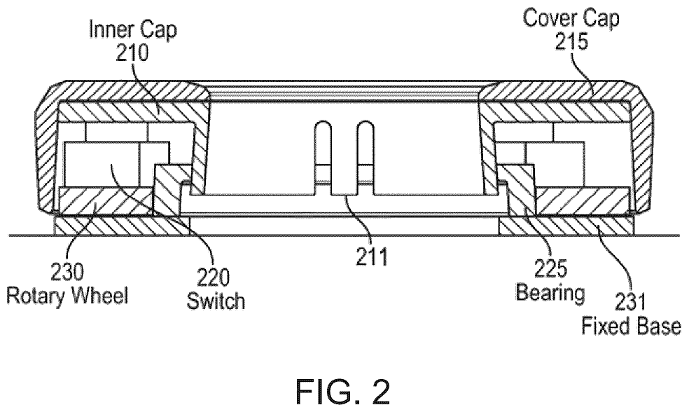

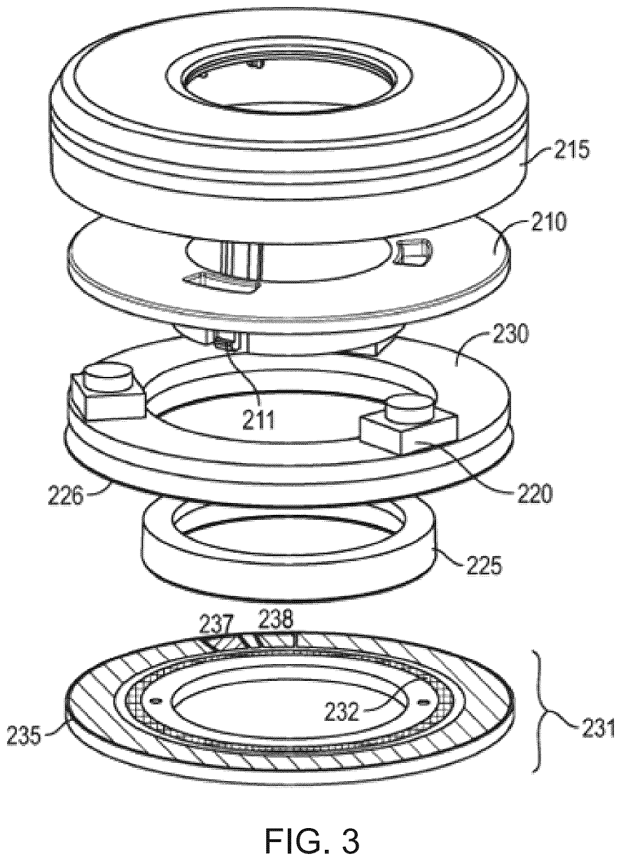

FIG. 2 illustrates six main components of an example rotatable knob interface, according to one or more embodiments. With reference thereto, starting at the bottom of the example device, there is shown a fixed base 231. In some embodiments, the fixed base 231 does not move as a user rotates the example knob interface. Thus, in some embodiments, it is affixed to the surface of an example input device, such as, for example, by an adhesive. In some embodiments, the fixed base 231 is affixed to the input device in a semi-permanent or permanent manner, and is placed thereon so as to align with a grid of electrodes provided in the input device. Provided above the fixed base 231 is a rotary wheel 230. The rotary wheel 230 turns as a user rotates the knob interface, such as, for example, by grasping and turning cover cap 215, as described below. At an inner side of the rotary wheel 230 is provided a vertical ring bearing 225. The vertical ring bearing 225 is non-conductive, and may be made of plastic, for example, and may have the shape of a ring. Vertical ring bearing 225 may have a substantially tubular shape. As described below with reference to FIG. 3, there is an additional substantially horizontal ring-shaped bearing upon which the rotary wheel 230 sits, according to one or more embodiments. By using both of the bearings, frictional forces between the fixed base 231, and the rotary wheel 230 may be reduced.

Continuing with reference to FIG. 2, provided on top of rotary wheel 230 are one or more switches 220. For example, switches 220 may be dome switches. There may be three switches 220, and the switches may be equidistantly placed on an upper surface of rotary wheel 230. As described more fully below, in one or more embodiments, the switches are used to distinguish between two states of the knob interface, namely a compressed state, in which the switches are closed, and an uncompressed state in which the switches remain open. The compression state of the knob interface is orthogonal to its internal rotational position. Thus, the knob interface may be rotated while in either a compressed or an uncompressed state (and in any position in between the two states), and that rotation may be sensed and measured. Similarly, the state of the switches as being open or closed, corresponding respectively to the knob interface being in the “home” or uncompressed state, or in the compressed state, may be detected whether or not the rotatable knob interface is rotationally stationary or being rotated.

Finally, continuing still with reference to FIG. 2, the knob interface has an inner cap 210, and a cover cap 215, as shown. In operation, a user physically interacts with cover cap 215, for example, by grasping cover cap 215 and rotating the rotary wheel 230 relative to the fixed base 231, or by pushing down on cover cap 215 to compress the knob interface and close the switches 220. As shown, the inner cap 210 is attached, by prongs 211, to a lip provided on the inner surface of vertical ring bearing 225. The cover cap 215 is attached to the inner cap 210, such that turning the outer cap 215 rotates the rotary wheel 230.

FIG. 3 illustrates an exploded view of the example rotatable knob interface of FIG. 2, illustrating the upper side of various components. With reference to FIG. 3, beginning at the bottom of the figure, there is shown the upper surface of fixed base 231. The upper surface is provided with a conductive peripheral ring 235, to be coupled to a reference signal of an input device to which the rotary knob is to be attached. As shown, the upper surface also shows an inner conducting ring 232 as well as two conductive pads 237 and 238. In one or more embodiments, these three conductive regions are configured to be coupled to a sensing signal of the input device.

Continuing with reference to FIG. 3, there are also shown the vertical ring bearing 225 and a horizontal ring-shaped bearing 226 configured to slide over it. In one or more embodiments, because the fixed base 231 has a smaller inner diameter than the rotary wheel 230, there is a ledge at the inner periphery of the fixed base 231 upon which the vertical ring bearing 225 may sit. The vertical ring bearing 225 is thus configured to fit inside the inner diameter of the horizontal ring bearing 226, and rest upon the inner periphery of the fixed base 231. The two bearings thus provide a physical interface between the fixed base 231 and the rotary wheel 230, as noted above, which reduces friction between them as the rotary wheel 230 is moved.

Continuing further with reference to FIG. 3, there are also shown three switches 220 provided around the upper surface of rotary wheel 230. As noted, these switches may be dome switches, for example. Above the switches 220 is shown the inner cap 210, which is configured to fit inside the vertical ring bearing 225, and be secured to the vertical ring bearing 225 via three prongs 211, which, in one or more embodiments are also placed equidistantly around the inner vertical surface of the vertical ring bearing 225. As shown, the inner cap 210 has a substantially horizontal upper ring, and a lower hollow cylindrical shaped portion. Thus, in one or more embodiments, the outer diameter of the lower cylindrical shaped portion of the inner cap 210, is designed to fit within an inner diameter of the vertical ring bearing 225, and then clamp to the bottom surface of the vertical ring bearing 225 by the prongs 211, which slightly protrude under such bottom surface when the inner cap 210 is in the home or uncompressed position. Finally, with reference to FIG. 3, the cover cap 215 is attached to the upper ring portion of the inner cap 210, as shown.

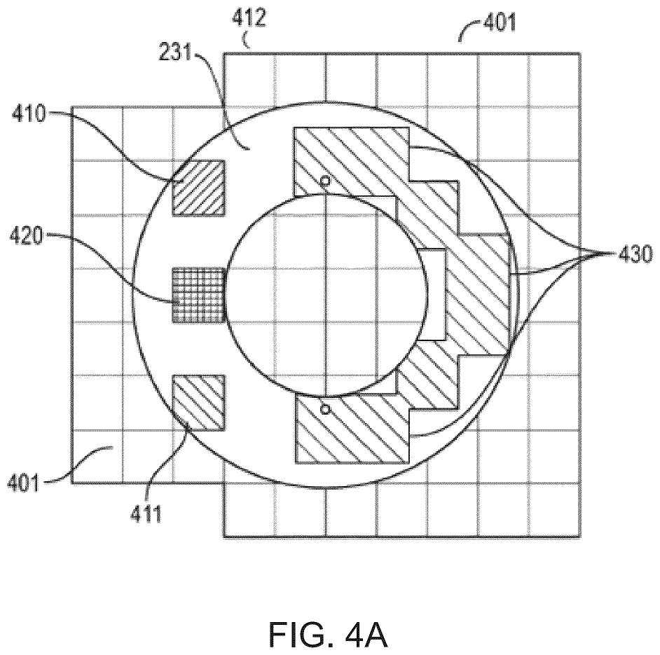

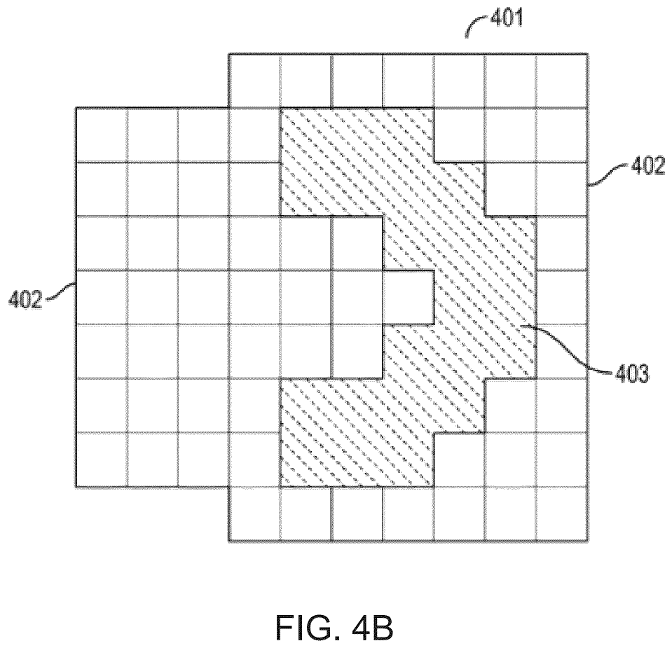

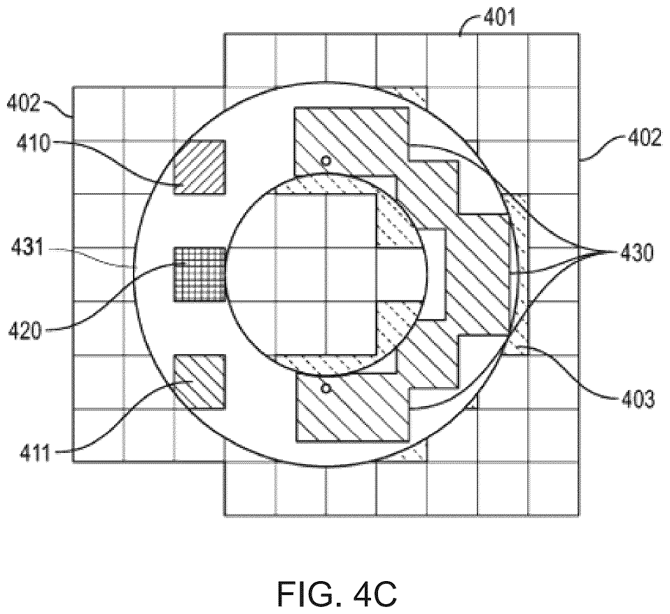

FIGS. 4A through 4C, next described, illustrate the spatial relationships between coupling electrodes provided on the bottom surface of the fixed base 231, respectively connected to corresponding conducting regions on the top surface of the fixed base 231, and electrodes in a grid provided in an example input device.

FIG. 4A illustrates a view of the underside of the fixed base 231 of an example rotatable knob interface shown in FIG. 3, superimposed over a grid of electrodes 401 of an example input device, according to one or more embodiments. With reference thereto, the bottom, or underside, of fixed base 231 has three sets of electrodes. A first set 430, shown as shaded, is a connected set of electrodes configured to receive a reference signal from the input device. Three electrodes 410, 420, 411, grouped into the remaining two sets, are configured to receive sensing waveforms of the input device. The second set, including electrodes 410 and 411, is configured to sense rotation of the knob interface. The third set, including electrode 420, is configured to sense a “click” or the closing of the switches 220, for example, when a user pushes the knob interface into its compressed state. As shown, the sensing electrodes 410, 411 and 420 are designed to each overlap with, to the extent possible, a full input device electrode (e.g., a square) of grid 401. On the other hand, the set of electrodes 430 may be designed to each overlap portions of multiple electrodes of grid 401, but not full electrodes, such that the set of electrodes 430 only pick up signal from the corresponding reference electrodes 403 (see FIG. 4B) on the grid 401 on the upper surface of the example input device, and do not pick up any parasitic capacitance from neighboring sensing electrodes. This isolation is illustrated in FIG. 4A by two features. First, there is an empty column 412 of sensing pixels to the right of sensing electrodes 410, 411 and 420 that provides a gap between the sensing electrodes 410, 411 and 420, and the set of electrodes 430. Second, the set of electrodes 430 (full line shading) are each recessed inwardly relative to the reference electrodes 403 (shaded with dotted lines) by, for example, 1.5-2 mm. This recessing helps the set of electrodes 430 to only pick up the reference electrode signal and much less so of the parasitic coupling of nearby sensing signals on sensing electrodes 402. Further, this feature also helps with tolerance alignment of the example rotatable knob interface to the input device.

FIG. 4B illustrates the example grid 401 of FIG. 4A divided into two types of electrodes, according to one or more embodiments. In general, each electrode of an input device's grid may be selectively chosen to be driven with a sensing waveform or a reference signal, such as, for example, ground, or other reference signal. In one or more embodiments, to coordinate its grid with the electrodes of the underside of a fixed base, as shown in FIG. 4A, the input device's grid may be arranged as shown in FIG. 4B. Thus, grid electrodes 403, shaded in FIG. 4B, may be driven by the input device with a reference signal, and grid electrodes 402 may be driven by the input device with a sensing signal. In one or more embodiments, when this scheme is implemented, there is a pairing between the underside of the fixed base 231, and the electrodes of grid 401 of an input device. This is illustrated in the superimposed view of FIG. 4C.

FIG. 4C thus illustrates the underside of fixed base 231 of FIG. 4A as positioned over the example input device electrode grid 401 of FIG. 4B, according to one or more embodiments. As shown, the sensing electrodes 410, 411 and 420, configured for sensing on the knob interface, are each substantially fully aligned with grid electrodes 402, to be driven with sensing waveforms. In one embodiment, they are driven with the same sensing waveforms. Similarly, the set of electrodes 430, configured for coupling to a reference signal of the input device, are each provided above multiple grid electrodes 403, to be driven with a reference signal by the input device. In one or more embodiments, because the fixed base 231 is stationary, and fixed in position relative to the input device, it is first aligned to the electrodes of the input device, as shown, and then, in one or more embodiments, permanently attached to a glass surface of the input device.

Thus, as shown, for example, in FIGS. 4A-4C, an exemplary rotatable knob may include a fixed base 231, which may be disposed over an array of electrodes of an input device (such as the sensing electrodes of a touchscreen display panel). Fixed base 231 may include two sensing electrodes 410, 411 on the fixed base 231 for sensing rotation of the knob interface, and the fixed base 231 may further include a ground pad 430, which may correspond to a set of grounded electrodes on the fixed base 231 which are configured to couple to corresponding grounded electrodes 403 of the input device driven with a reference signal and thereby provide capacitive loading for knob sensing through the sensing electrodes of the fixed base.

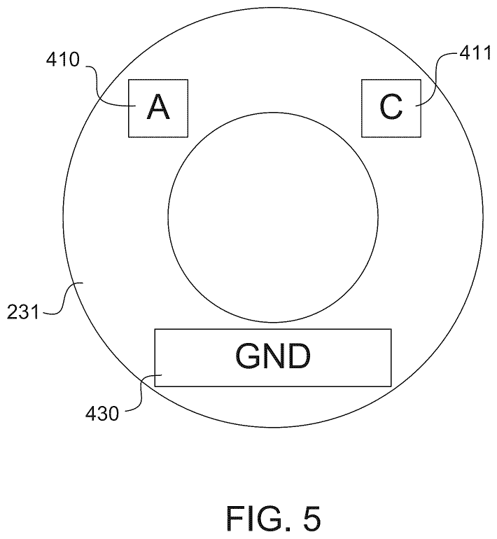

FIG. 5 depicts a simplified illustration of a fixed base 231 of a rotatable knob interface. Fixed base 231 includes knob sensing electrodes 410 and 411 corresponding respectively to sensing channels “A” and “C”. The fixed base 231 also includes a ground pad 430 corresponding to a ground channel “GND”.

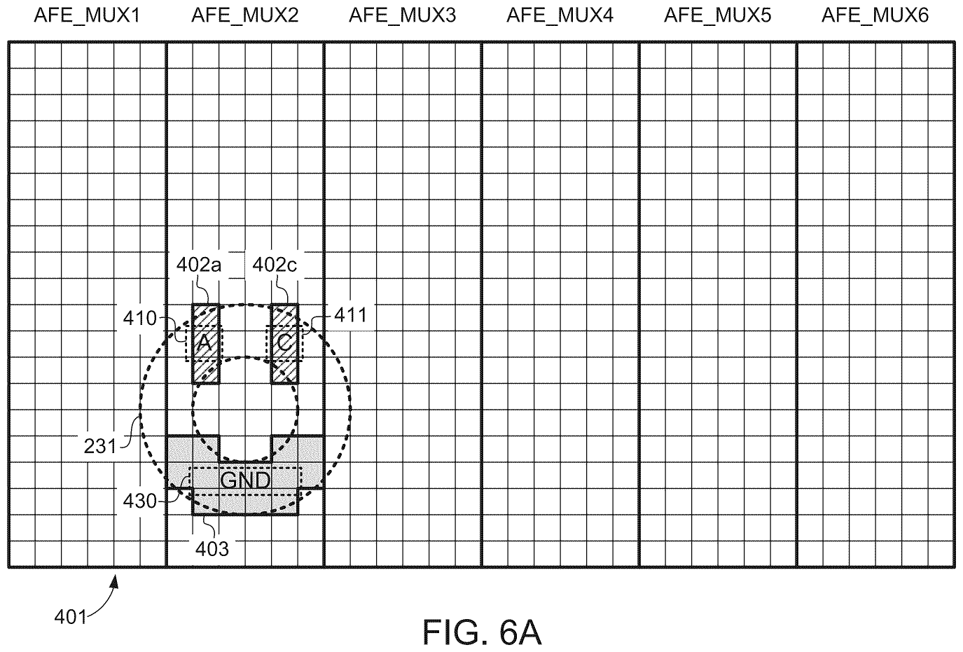

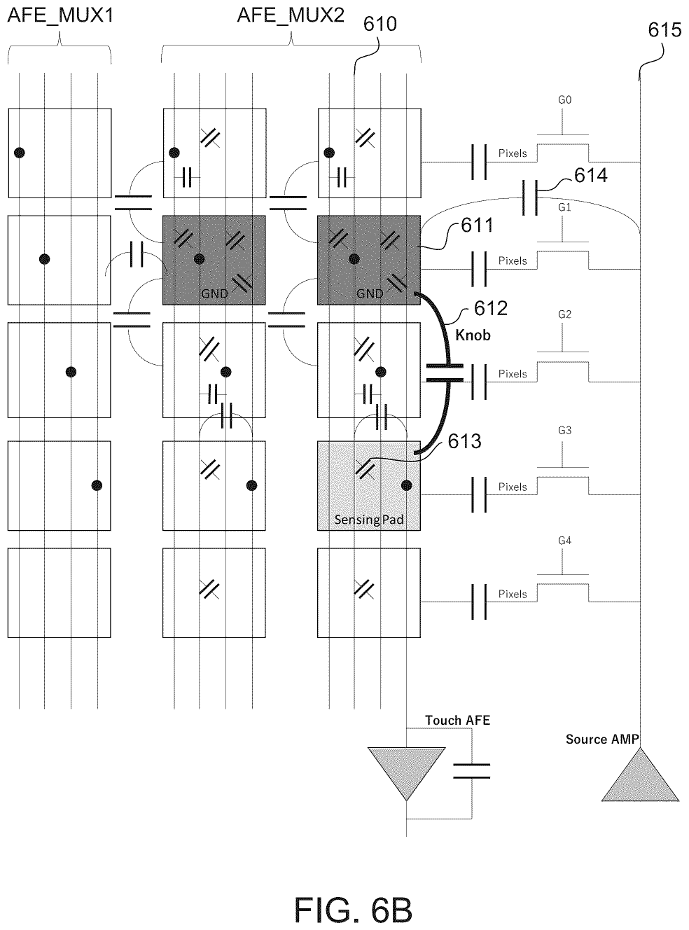

FIG. 6A depicts the fixed base 231 of FIG. 5 overlaid on an exemplary display panel having a plurality of sensing electrodes. The plurality of sensing electrodes may be sensor pads for absolute capacitance sensing arranged in a sensor grid 401 (wherein each square corresponds to a respective sensing electrode formed as a sensor pad). The sensor grid 401 may include several “slices” corresponding to respective “muxes.” In FIG. 6A, six slices are depicted (corresponding to the regions labeled “AFE_MUX1” through “AFE_MUX6”), wherein each respective slice includes 6 columns of 20 sensing electrodes, and the sensing electrodes in each respective slice are coupled to a respective analog front end (AFE) portion of a processing system. It will be appreciated that display panels may have different numbers of slices in different implementations, and that respective slices may include different numbers of sensing electrodes in different implementations. It will further be appreciated that a processing system may operate the sensor grid 401 in a time-division-multiplexed manner, with sensing for each respective slice being performed in a respective time instance for that slice (in one respective time instance corresponding to a respective slice, one measurement is obtained via each sensing electrode under measurement within the slice, such that respective measurements are obtained for all respective sensing electrodes under measurement within the slice during the one time instance).

In the configuration shown in FIG. 6A, knob sensing electrodes 410 and 411 of fixed base 231 respectively overlap knob sensing electrodes 402a and 402c of sensor grid 401, and ground pad 430 of fixed base 231 overlaps reference electrodes 403 of sensor grid 401. Thus, the reference electrodes 403 are configured to provide a reference ground signal to ground pad 430 of fixed base 231, and knob sensing electrodes 402a and 402c are configured to obtain knob rotation sensing signals from knob sensing electrodes 410 and 411 of fixed base 231.

For column-shaped slices (such as AFE_MUX1 through AFE_MUX6 of FIG. 6A), a plurality of vertical traces (which may be M3 wires) are disposed over each respective column of sensing electrodes to carry signals from respective sensing electrodes to a respective analog front end (AFE) corresponding to the respective slice that contains the respective column of sensing electrodes. Thus, for example, in the second column within AFE_MUX2, the vertical traces for that column overlap both the knob sensing electrodes 402a and a subset of electrodes out of the reference electrodes 403 such that vertical traces which carry a reference ground signal for ground pad 430 pass over knob sensing electrodes 402a. This results in extra loading on knob sensing electrodes 402a, and thereby causes a slower settling time of the knob sensing waveform corresponding to knob sensing electrodes 402a and results in worse sensing performance (e.g., with respect to sensing speed and signal-to-noise ratio (SNR)). Similarly, for example, in the fourth column within AFE_MUX2, the vertical traces for that column overlap both the knob sensing electrodes 402c and a subset of electrodes out of the reference electrodes 403 such that vertical traces which carry a reference ground signal for ground pad 430 pass over knob sensing electrodes 402c. This results in extra loading on knob sensing electrodes 402c, and thereby causes worse sensing performance with respect to those knob sensing electrodes as well. Further, the vertical traces which carry a reference ground signal for ground pad 430 may be proximate to a nearby display source line (which may also be vertically disposed in the same column), thereby loading the display line and causing interference associated with the display.

It will be appreciated that the vertical traces of each respective AFE_MUX connect sensor electrodes of the respective AFE_MUX to a corresponding respective AFE of the processing system (e.g., processing system 110 of FIG. 1). To perform knob sensing, the processing system may, for example, provide a reference signal to the reference electrodes 403 and sensing signals to knob sensing electrodes 402a, 402c, as well as obtain resulting signals from knob sensing electrodes 402a, 402c.

FIG. 6B depicts an illustrative example of how grounded reference electrodes and their corresponding vertical traces cause capacitive loading on a nearby knob sensing pad and a nearby display source line based on the location and orientation of the fixed base of a rotatable knob shown in FIG. 6A. In particular, as can be seen in FIG. 6B, the vertical trace 610 connected to a reference GND electrode 611 in the second column of AFE_MUX2 also overlaps the knob sensing pad in the second column of AFE_MUX2, thereby causing undesirable capacitive loading 613 from the vertical trace 610 onto the knob sensing pad. Thus, in addition to the desired coupling 612 between the reference GND electrode and the knob sensing pad which provides knob loading for the knob sensing operation, there is also undesirable coupling 613 between a grounded vertical trace 610 and the knob sensing pad. Additionally, the reference GND electrode 611 itself is proximate to a display source line 615 connected to a plurality of pixels of the display panel and causes undesirable capacitive loading 614 from the reference GND electrode onto the display source line 615.

It will be appreciated that FIG. 6B is illustrative in the sense that the electrodes of the sensor grid depicted in FIG. 6B are not in a 1:1 relationship relative to the electrodes of the sensor grid depicted in FIG. 6A, and that FIG. 6B is merely intended to conceptually illustrate certain capacitive loadings that exist during operation due to the configuration of the rotatable knob system depicted in FIG. 6A.

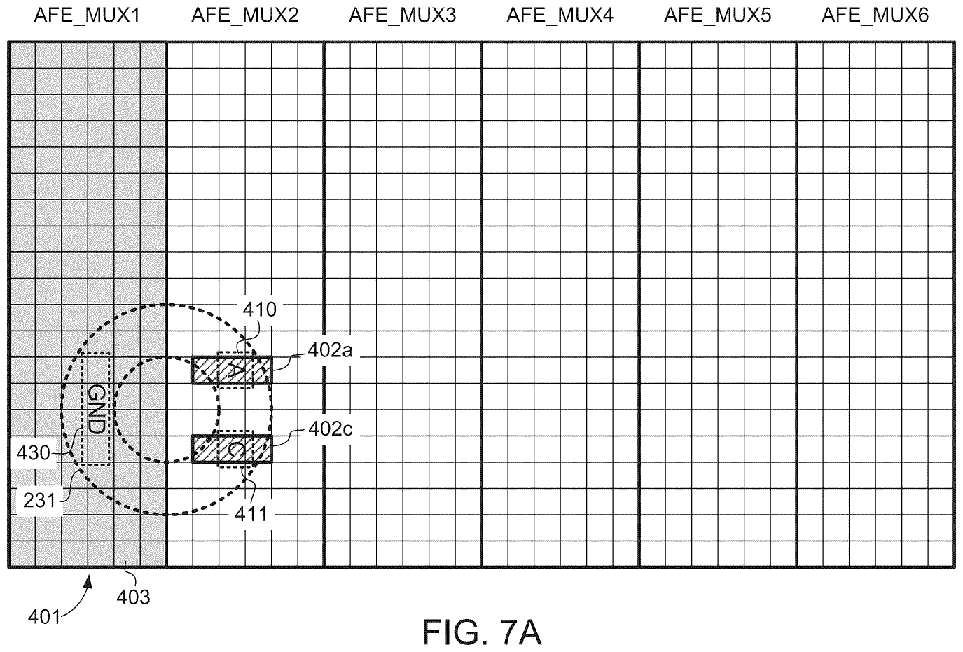

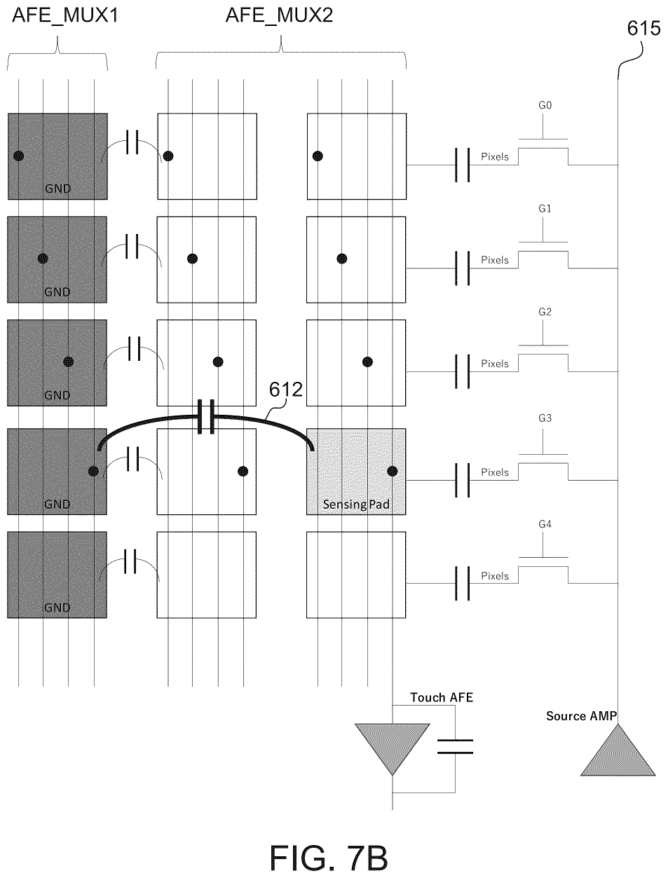

FIG. 7A depicts the fixed base 231 of FIG. 5 overlaid on an exemplary display panel having a plurality of sensing electrodes in accordance with an exemplary embodiment of the present disclosure. Relative to the configuration shown in FIG. 6A, the fixed base 231 in FIG. 7A has been rotated 90°, and the fixed base 231 is disposed over both the AFE_MUX1 and AFE_MUX2 regions such that the ground pad 430 of the fixed base 231 is disposed entirely within the AFE_MUX1 region and the knob sensing electrodes 410 and 411 of the fixed base 231 are disposed entirely within the AFE_MUX2 region. In this example, all electrodes of AFE_MUX1 are grounded (such that the entirety of the AFE_MUX1 region can be considered as being the reference electrodes 403) while knob sensing is performed within the AFE_MUX2 region through knob sensing electrodes 402a and 402c. It will be appreciated that, in the example depicted in FIG. 7A, to perform touch sensing and knob sensing for the display panel, there may be seven distinct time instances for a full scan of the touchscreen display panel, including six time instances for performing touch sensing in the six AFE_MUX regions, as well as an additional time instance for performing knob sensing in the AFE_MUX2 region where the knob sensing electrodes for knob sensing are located.

FIG. 7B depicts an illustrative example of capacitive loadings caused by grounded reference electrodes and their corresponding vertical traces based on the location and orientation of the fixed base of a rotatable knob shown in FIG. 7A. As shown in FIG. 7B, the reference electrodes of AFE_MUX1 and their corresponding vertical traces, which are disposed in the AFE_MUX1 region, do not result in capacitive loading being imposed on the knob sensing pad and the source display line 315 in the AFE_MUX2 region, other than the desired coupling 612 between the reference GND electrode and the knob sensing pad which provides knob loading for the knob sensing operation. Thus, relative to the configuration shown in FIG. 6A, the configuration shown in FIG. 7A provides for faster settling time of the knob sensing channels, less interference with the display signal, and higher SNR.

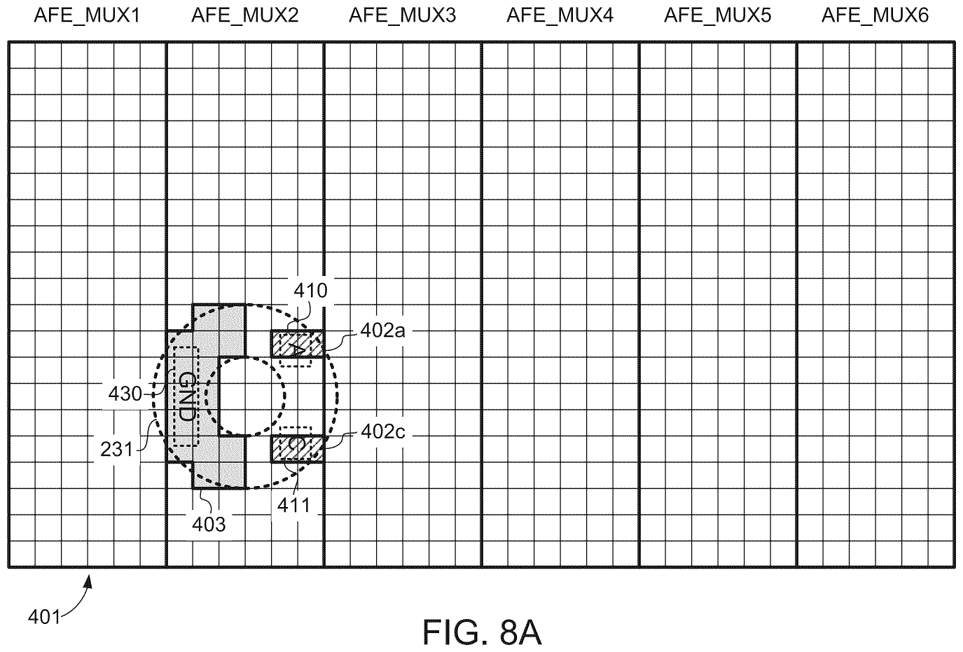

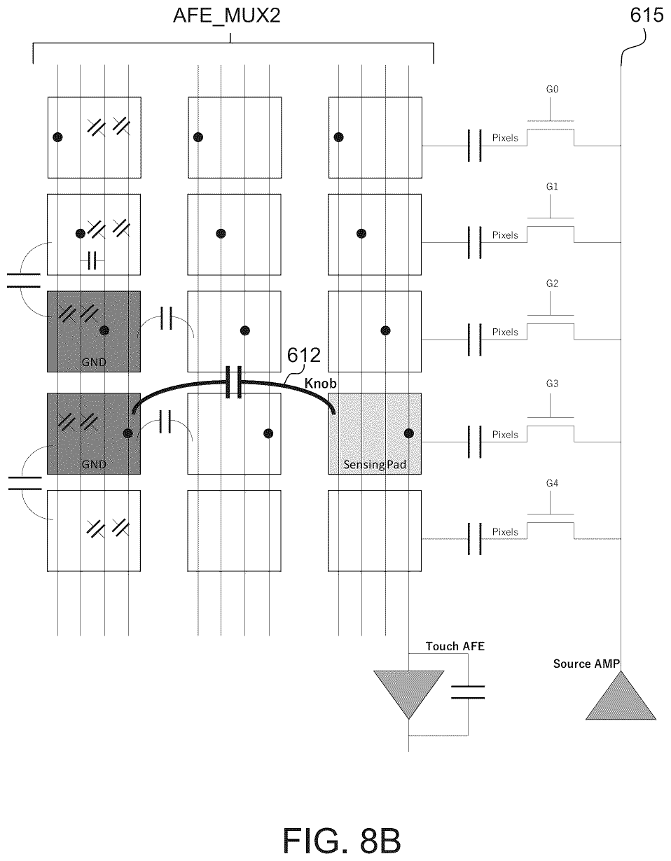

FIG. 8A depicts the fixed base 231 of FIG. 5 overlaid on an exemplary display panel having a plurality of sensing electrodes in accordance with another exemplary embodiment of the present disclosure. Relative to the configuration shown in FIG. 6A, the fixed base 231 in FIG. 8A has been rotated 90°, and the fixed base 231 is disposed entirely within the AFE_MUX2 region in a manner such that vertical traces for the reference electrodes 403 do not overlap with the knob sensing electrodes 402a and 402c. In this example, both touch sensing and knob sensing for the AFE_MUX2 region may be performed together in a single time instance for the AFE_MUX2 region. It will thus be appreciated that, in the example depicted in FIG. 8A, to perform touch sensing and knob sensing for the display panel, there may be six distinct time instances for a full scan of the touch screen display panel, including a first time instance for performing touch sensing in the AFE_MUX1 region, a second time instance for performing both touch and knob sensing in the AFE_MUX2 region, and third, fourth, fifth and sixth time instances for performing touch sensing in the AFE_MUX3, AFE_MUX4, AFE_MUX5 and AFE_MUX6 regions, respectively.

FIG. 8B depicts an illustrative example of capacitive loadings caused by grounded reference electrodes and their corresponding vertical traces based on the location and orientation of the fixed base of a rotatable knob shown in FIG. 8A. As shown in FIG. 8B, the reference GND electrodes of AFE_MUX2 and their corresponding vertical traces do not result in capacitive loading being imposed on the knob sensing pad and the source display line 615, other than the desired coupling 612 between the reference GND electrode and the knob sensing pad which provides knob loading for the knob sensing operation. Thus, relative to the configuration shown in FIG. 6A, the configuration shown in FIG. 8B provides for faster settling time of the knob sensing channels, less interference with the display signal, and higher SNR.

Exemplary embodiments of the present disclosure provide for improving the performance of knob sensing systems wherein a rotatable knob is disposed over a sensing array by avoiding undesirable capacitive couplings between grounded traces of the sensing array and other elements (including knob sensing electrodes and display source lines). Unlike conventional knob sensing systems in which grounded traces of the sensing array overlap with knob sensing electrodes, the fixed base of a rotatable knob in accordance with exemplary embodiments of the present disclosure is oriented and located relative to a sensing array so as to avoid such overlap (and may further be oriented and located to avoid or minimize capacitive coupling from grounded traces of the sensing array to display source lines).

To test the efficacy of exemplary embodiments of the present disclosure, SNR measurements were conducted in connection with an exemplary implementation of a rotatable knob system according to the present disclosure and a conventional rotatable knob system. Through these tests, the rotatable knob system according to the present disclosure was shown to have improved SNR relative to a conventional rotatable knob system (for the systems tested, the improvement was about 7-8 dB on average, corresponding to an SNR improvement of about 100-150%). Additionally, the two systems were also tested under different knob statuses (OFF/OFF and ON/ON) and under different image conditions (black image and white image), and it was demonstrated that, relative to a conventional rotatable knob system, the rotatable knob system according to the present disclosure avoided significant ADC shift corresponding to display image switching due to there being less loading on display source lines (ADC shift in this context refers to a shift in the values output by an analog-to-digital converter (ADC) of an AFE caused by capacitive loading on display source lines relative to baseline reference ADC values).

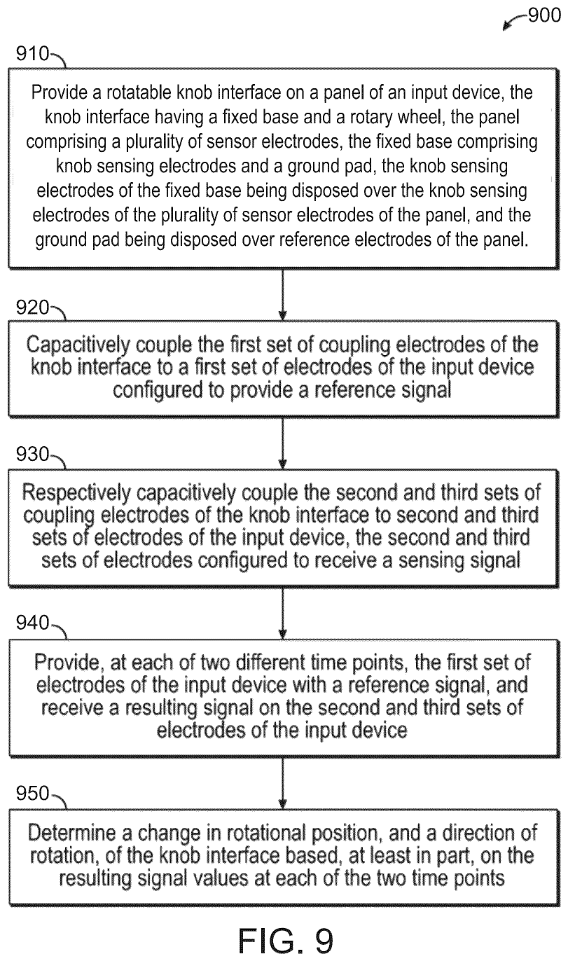

FIG. 9 is a process flowchart illustrating a method 900 for implementing a rotatable knob interface on an example electronic device, and determining a position and/or state of the rotatable knob interface according to one or more embodiments. For example, the electronic device may be a combined display and sensing device, such as one that, for example, includes TDDI technology, as described above.

Method 900 includes blocks 910 through 950. In alternate embodiments, method 900 may have more, or fewer, blocks. Method 900 begins at block 910, where a rotatable knob interface is provided on an input device, the rotatable knob interface having a fixed base and a rotary wheel. The panel comprises a plurality of sensor electrodes, the fixed base comprises knob sensing electrodes and a ground pad, the knob sensing electrodes of the fixed base are disposed over the knob sensing electrodes of the plurality of sensor electrodes of the panel, and the ground pad is disposed over reference electrodes of the panel. The panel further comprises a plurality of traces which connect the knob sensing electrodes of the panel to a processing system, and the plurality of traces connecting the knob sensing electrodes of the panel to the processing system do not overlap with the reference electrodes of the panel. Further, the fixed base has first, second and third sets of coupling electrodes on a bottom surface, and a top surface with a peripheral portion including first second and third regions electrically connected to each of the first, second and third sets of coupling electrodes. The rotary wheel has a bottom surface provided with alternating conductive and non-conductive regions.

From block 910, method 900 proceeds to block 920, where the first set of coupling electrodes of the knob interface is capacitively coupled to a first set of electrodes of the input device configured to provide a reference signal. For example, the first set of electrodes may be electrodes 430 of FIG. 4A. Or, for example, the set of first electrodes may include a single electrode. As regards the reference signal, for example, it may be a ground signal generated by processing circuitry of the electronic device, such as, for example, the processing circuitry 110 of the electronic device 100 of FIG. 1. As another example, the reference signal may be a ground signal output by a TDDI device from an arbitrarily chosen analog front end.

From block 920, method 900 proceeds to block 930, where the second and third sets of coupling electrodes of the knob interface are capacitively coupled to second and third sets of electrodes of the input device, the second and third sets of electrodes configured to receive a sensing signal. For example, the second and third sets of coupling electrodes may be the electrodes 410 and 411 of FIG. 4A, and they may all be coupled to ones of input device electrodes 402 of FIG. 4B. In some embodiments, the same sensing signal is provided to all of device electrodes 402 of FIG. 4B, and thus the second and third sets of coupling electrodes are coupled to the same signal.

From block 930, method 900 proceeds to block 940, where, at each of two different time points, the first set of electrodes of the input device is provided with a reference signal, and a resulting signal is then received on the second and third sets of electrodes of the input device. As noted above, the resulting signal is the same signal used to drive each of the second and third sets of electrodes, except that when it is measured, it has been modified by the relative rotational positions of the fixed base and rotary wheel of the rotatable knob interface. As noted, the second and third sets of electrodes of the input device may be driven with the same sensing signal.

From block 940, method 900 proceeds to block 950, where, based at least in part on the data obtained at each of the two different time points, a change in rotational position and a direction of rotation of the knob interface is determined. In one or more embodiments, this determination may be performed by firmware stored in a memory of the input device.

It will be appreciated that, as discussed above, blocks 920-950 of FIG. 9 may be performed together with touch sensing for a respective slice in which the knob sensing electrodes of the rotatable knob interface is located such that both touch and knob sensing for the respective slice in a single time instance, or blocks 920-950 of FIG. 9 may be performed in a dedicated time instance for knob sensing in which touch sensing is not performed.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A rotatable knob system, comprising:
a panel comprising a plurality of sensor electrodes; and
a rotatable knob interface comprising a rotary wheel and a fixed base, wherein the fixed base comprises knob sensing electrodes and a ground pad, wherein the ground pad of the fixed base is larger than the knob sensing electrodes of the fixed base;
wherein the knob sensing electrodes of the fixed base are disposed over knob sensing electrodes of the plurality of sensor electrodes of the panel, and the ground pad is disposed over reference electrodes of the panel, wherein a reference area of the panel corresponding to the reference electrodes of the panel is larger than a knob sensing area of the panel corresponding to the knob sensing electrodes of the panel; and
wherein the panel comprises a plurality of traces which connect the knob sensing electrodes of the panel to a processing system, and wherein the plurality of traces connecting the knob sensing electrodes of the panel to the processing system do not overlap with the reference electrodes of the panel.

2. The rotatable knob system according to claim 1, wherein the panel is a touch-sensitive display panel.

3. The rotatable knob system according to claim 1, wherein the panel comprises a plurality of slices corresponding respectively to a plurality of analog front ends (AFEs), wherein the plurality of sensor electrodes of the panel include a first plurality of sensor electrodes corresponding to a first slice of the plurality of slices and a second plurality of sensor electrodes corresponding to a second slice of the plurality of slices.

4. The rotatable knob system according to claim 3, wherein the ground pad of the fixed base is disposed over the first slice, and wherein the knob sensing electrodes of the fixed base are disposed over the second slice.

5. The rotatable knob system according to claim 3, wherein the ground pad of the fixed base and the knob sensing electrodes of the fixed base are disposed in the same slice.

6. The rotatable knob system according to claim 3, wherein the knob sensing electrodes of the fixed base are disposed over the second slice;
wherein the system further comprises the processing system; and
wherein the processing system is configured to perform knob sensing via the knob sensing electrodes of the panel in a same time instance as performing touch sensing for the second slice.

7. The rotatable knob system according to claim 3, wherein the knob sensing electrodes of the fixed base are disposed over the second slice;
wherein the system further comprises the processing system; and
wherein the processing system is configured to perform knob sensing via the knob sensing electrodes of the panel in a time instance during which touch sensing is not performed.

8. A rotatable knob system, comprising:
a panel comprising a plurality of sensor electrodes; and
a rotatable knob interface comprising a rotary wheel and a fixed base, wherein the fixed base comprises knob sensing electrodes and a ground pad, wherein the ground pad of the fixed base is larger than the knob sensing electrodes of the fixed base;
wherein the knob sensing electrodes of the fixed base are disposed over knob sensing electrodes of the plurality of sensor electrodes of the panel, and the ground pad is disposed over reference electrodes of the panel, wherein a reference area of the panel corresponding to the reference electrodes of the panel is larger than a knob sensing area of the panel corresponding to the knob sensing electrodes of the panel; and
wherein the panel comprises a first plurality of traces which connect the knob sensing electrodes of the panel to a processing system and a second plurality of traces which connect the reference electrodes of the panel to the processing system, wherein the second plurality of traces are separate from the first plurality of traces.

9. The rotatable knob system according to claim 8, wherein the panel is a touch-sensitive display panel.

10. The rotatable knob system according to claim 8, wherein the panel comprises a plurality of slices corresponding respectively to a plurality of analog front ends (AFEs), wherein the plurality of sensor electrodes of the panel include a first plurality of sensor electrodes corresponding to a first slice of the plurality of slices and a second plurality of sensor electrodes corresponding to a second slice of the plurality of slices.

11. The rotatable knob system according to claim 10, wherein the ground pad of the fixed base is disposed over the first slice, and wherein the knob sensing electrodes of the fixed base are disposed over the second slice.

12. The rotatable knob system according to claim 10, wherein the ground pad of the fixed base and the knob sensing electrodes of the fixed base are disposed in the same slice.

13. The rotatable knob system according to claim 10, wherein the knob sensing electrodes of the fixed base are disposed over the second slice;
wherein the system further comprises the processing system; and
wherein the processing system is configured to perform knob sensing via the knob sensing electrodes of the panel in a same time instance as performing touch sensing for the second slice.

14. The rotatable knob system according to claim 10, wherein the knob sensing electrodes of the fixed base are disposed over the second slice;
wherein the system further comprises the processing system; and
wherein the processing system is configured to perform knob sensing via the knob sensing electrodes of the panel in a time instance during which touch sensing is not performed.

15. A method for knob sensing, comprising:
providing a rotatable knob interface on a panel of an input device, the knob interface having a fixed base and a rotary wheel, wherein the panel comprises a plurality of sensor electrodes, wherein the fixed base comprises knob sensing electrodes and a ground pad, wherein the ground pad of the fixed base is larger than the knob sensing electrodes of the fixed base, wherein the knob sensing electrodes of the fixed base are disposed over knob sensing electrodes of the plurality of sensor electrodes of the panel, and the ground pad is disposed over reference electrodes of the panel, wherein a reference area of the panel corresponding to the reference electrodes of the panel is larger than a knob sensing area of the panel corresponding to the knob sensing electrodes of the panel, wherein the panel comprises a plurality of traces which connect the knob sensing electrodes of the panel to a processing system of the input device, and wherein the plurality of traces connecting the knob sensing electrodes of the panel to the processing system do not overlap with the reference electrodes of the panel;
providing, by the processing system, a reference signal to the reference electrodes of the panel and sensing signals to the knob sensing electrodes of the panel;
obtaining, by the processing system, resulting signals via the knob sensing electrodes of the panel; and
determining a change in rotational position and a direction of rotation of the knob interface based, at least in part, on the obtained resulting signals.

16. The method according to claim 15, wherein the panel comprises a plurality of slices corresponding respectively to a plurality of analog front ends (AFEs), wherein the plurality of sensor electrodes of the panel include a first plurality of sensor electrodes corresponding to a first slice of the plurality of slices and a second plurality of sensor electrodes corresponding to a second slice of the plurality of slices.

17. The method according to claim 16, wherein the ground pad of the fixed base is disposed over the first slice, and wherein the knob sensing electrodes of the fixed base are disposed over the second slice.

18. The method according to claim 16, wherein the ground pad of the fixed base and the knob sensing electrodes of the fixed base are disposed in the same slice.

19. The rotatable knob system according to claim 16, wherein the knob sensing electrodes of the fixed base are disposed over the second slice; and
wherein knob sensing is performed via the knob sensing electrodes of the panel in a same time instance as performing touch sensing for the second slice.

20. The rotatable knob system according to claim 16, wherein the knob sensing electrodes of the fixed base are disposed over the second slice; and
wherein knob sensing is performed via the knob sensing electrodes of the panel in a time instance during which touch sensing is not performed.
